(19) United States
(12) Patent Application Publication
(10) Pub. No.: US 2019/0017309 A1
(43) Pub. Date: Jan. 17, 2019

(54) VEHICLE DOOR APPARATUS

(71) Applicant: AISIN SEIKI KABUSHIKI KAISHA, Kariya-shi (JP)

(72) Inventors: Dai Hidaka, Obu-shi (JP); Kenji Hori, Toyota-shi (JP)

(73) Assignee: AISIN SEIKI KABUSHIKI KAISHA, Kariya-shi (JP)

(21) Appl. No.: 16/028,875

(22) Filed: Jul. 6, 2018

(30) Foreign Application Priority Data
Jul. 11, 2017 (JP) 2017-135541

(51) Int. Cl. E05F 5/00; E05B 81/00; E05B 85/26; E05B 83/36

(52) U.S. Cl. CPC E05F 5/00; E05B 81/00; B60J 5/04; E05B 83/36; E05B 85/26

(57) ABSTRACT

A vehicle door apparatus includes: an electric door lock unit configured to switch between a locked state of restricting an opening/closing operation of a swing door and an unlocked state of permitting the opening/closing operation of the swing door; an operation detection unit configured to detect an operation request of the swing door by an operator; an electric door check unit provided on the swing door and configured to switch between a holding state of applying a holding force to the swing door for holding the swing door at an arbitrary degree of opening and a non-holding state of not applying the holding force; and a controller configured to switch the electric door lock unit from the locked state to the unlocked state and to set the electric door check unit in the non-holding state when the operation request is detected.

### CROSS REFERENCE TO RELATED APPLICATIONS

This application is based on and claims priority under 35 U.S.C. § 119 to Japanese Patent Application 2017-135541, filed on Jul. 11, 2017, the entire contents of which are incorporated herein by reference.

### TECHNICAL FIELD

This disclosure relates to a vehicle door apparatus.

### BACKGROUND DISCUSSION

In the related art, JP 2002-371737 A (Reference 1) discloses a vehicle door apparatus, in which a latch mechanism, provided in a door for a vehicle, is electrically released in response to an electric signal from an inside handle switch and an outside handle switch. Such a vehicle door apparatus generally includes a door check device, which applies a door holding force (check holding force) stepwise so as to maintain the door at the half-opened position and at the fully-opened position based on the degree of opening of the door after the latch mechanism is released.

However, in the vehicle door apparatus described above, in a case where the operation load applied to the door may be small at the time of opening/closing the door, for example, even when the swing door is slightly opened/closed, the door holding force is applied to the swing door, which may make an operator feel the operation load of the swing door heavy.

Thus, a need exists for a vehicle door apparatus which is not susceptible to the drawback mentioned above.

### SUMMARY

A vehicle door apparatus according to an aspect of this disclosure includes an electric door lock unit configured to switch an operating state thereof between a locked state of restricting an opening/closing operation of a swing door with respect to a vehicle body and an unlocked state of permitting the opening/closing operation of the swing door with respect to the vehicle body, an operation detection unit configured to detect an operation request of the swing door by an operator, an electric door check unit provided on the swing door and configured to switch an operating state thereof between a holding state of applying a holding force to the swing door for holding the swing door at an arbitrary degree of opening and a non-holding state of not applying the holding force to the swing door, and a controller configured to switch the electric door lock unit from the locked state to the unlocked state and to set the electric door check unit in the non-holding state when the operation request is detected via the operation detection unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a vehicle having a swing door;

FIG. 2 is an enlarged plan view of the vicinity of a swing door;

FIG. 3 is a perspective view of the swing door, which is operated to open;

FIG. 4 is a perspective view of the swing door in a fully closed state;

FIG. 5A is an enlarged cross-sectional view of a latch mechanism in the locked state, FIG. 5B is an enlarged sectional view of the latch mechanism in the half-locked state, and FIG. 5C is an enlarged cross-sectional view of the latch mechanism in the unlocked state;

FIG. 6 is a schematic diagram illustrating the electrical connection of a door ECU; and

FIG. 7 is a control flowchart of a vehicle door apparatus when an operator operates the swing door.

### DETAILED DESCRIPTION

Hereinafter, an embodiment of a vehicle door apparatus will be described with reference to the accompanying drawings.

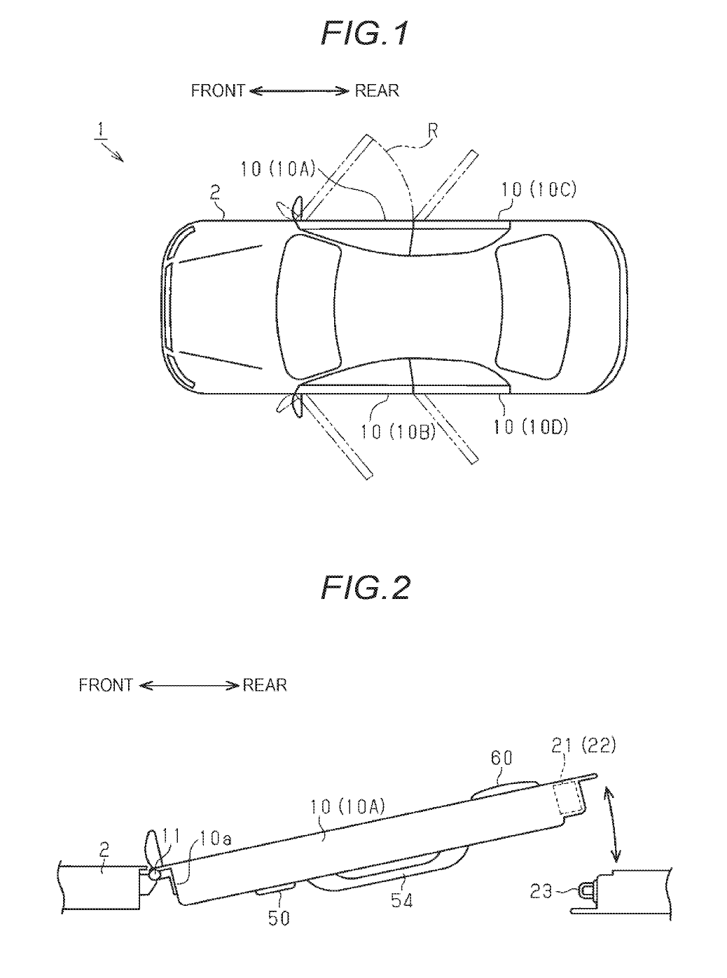

As illustrated in FIG. 1, a vehicle 1 includes four swing doors 10 (10A to 10D), which open/close a door opening formed in the side surface of a vehicle body 2. Each swing door 10 corresponds to each of front, rear, right and left seats (not illustrated) disposed in a vehicle room.

As illustrated in FIG. 2, a front end portion 10a of each swing door 10 is supported on the vehicle body 2 via a hinge 11. Each swing door 10 pivots about the hinge 11 to open/close the door opening. A weather strip (not illustrated), which is formed of a waterproof material having an elastic force, is provided around the entire circumference of the door opening. That is, when the swing door 10 is operated to close, the swing door 10 moves to the fully closed position in a manner such that it forcibly crushes the weather strip. This prevents, for example, rainwater from entering the vehicle room from a gap between the door opening and the swing door 10.

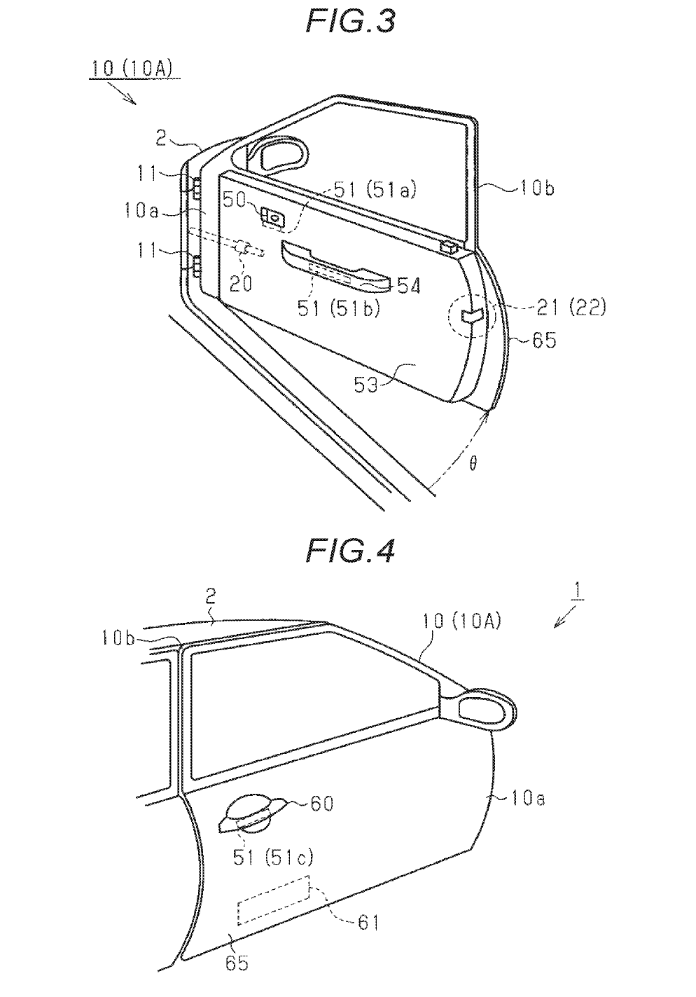

As illustrated in FIG. 3, an inner panel 53 of the swing door 10, which faces the indoor side, is provided with an inside handle 50 and a grip part 54. The inside handle 50 is provided with a contact sensor 51a, and the grip part 54 is provided with a contact sensor 51b. The contact sensor 51a detects an object that is in contact with the inside handle 50. The contact sensor 51b detects an object that is in contact with the grip part 54.

In addition, as illustrated in FIG. 4, the swing door 10 is provided with an outside handle 60. The outside handle 60 is provided on an outer panel of a door main body 65 of the swing door 10, which faces the outdoor side. The outside handle 60 is provided with a contact sensor 51c. The contact sensor 51c detects an object that is in contact with the outside handle 60. In addition, the door main body 65 is provided with a non-contact sensor 61. The non-contact sensor 61 detects an object that approaches the door main body 65 from the outside.

An electrostatic capacity sensor is adopted for the contact sensors 51a, 51b and 51c and the non-contact sensor 61. The object detected by the contact sensors 51a, 51b and 51c is the hand of the operator who operates the swing door 10. That is, the contact sensors 51a, 51b and 51c detect an operation request from the operator who operates the swing door 10. An operation detection unit 51 is configured to detect the operation request from the operator of the swing door 10 using the contact sensors 51a, 51b and 51c.

The object detected by the non-contact sensor 61 is an obstacle on the rotation locus R (see FIG. 1) of the swing door 10. As the obstacle, for example, a person who passes the vicinity of the side surface of the vehicle 1, an adjacent vehicle, or a curbing that exists in the vicinity of the side surface of the vehicle 1 is conceivable. In addition, the non-contact sensor 61 is an example of an obstacle detection unit.

As illustrated in FIG. 3, the swing door 10 includes a door check device 20 as an electric door check unit. The door check device 20 is provided at the front end portion 10a of each swing door 10. The door check device 20 has a function of applying a check holding force to the swing door 10 for holding each swing door 10 at an arbitrary opening operation angle θ based on signals output from the contact sensors 51a, 51b and 51c. More specifically, the door check device 20 switches the operating state thereof between a non-holding state of holding the swing door 10 in a state of being operable so as to be opened/closed by applying no check holding force to the swing door 10 when the swing door 10 is operated to be opened/closed and a holding state of holding the swing door 10 at the arbitrary opening operation angle θ by applying a check holding force to the swing door 10 when the swing door 10 is not operated to be opened/closed. In addition, when the swing door 10 is in the fully closed state, the door check device 20 maintains the state of applying the check holding force to the swing door 10.

In addition, the swing door 10 includes a door lock device 21 as an electric door lock unit. The door lock device 21 is provided at a rear end portion 10b of each swing door 10. The door lock device 21 has a function of switching the engagement state of each swing door 10 with respect to the vehicle body 2 between the locked state and the unlocked state based on the signals output from the contact sensors 51a, 51b and 51c. The door lock device 21 includes a latch mechanism 22, which switches the engagement state with respect to a striker 23 (see FIG. 2), provided on the rear side of the door opening in the vehicle body 2, between the locked state and the unlocked state, and an electric actuator (not illustrated) for operating the latch mechanism 22.

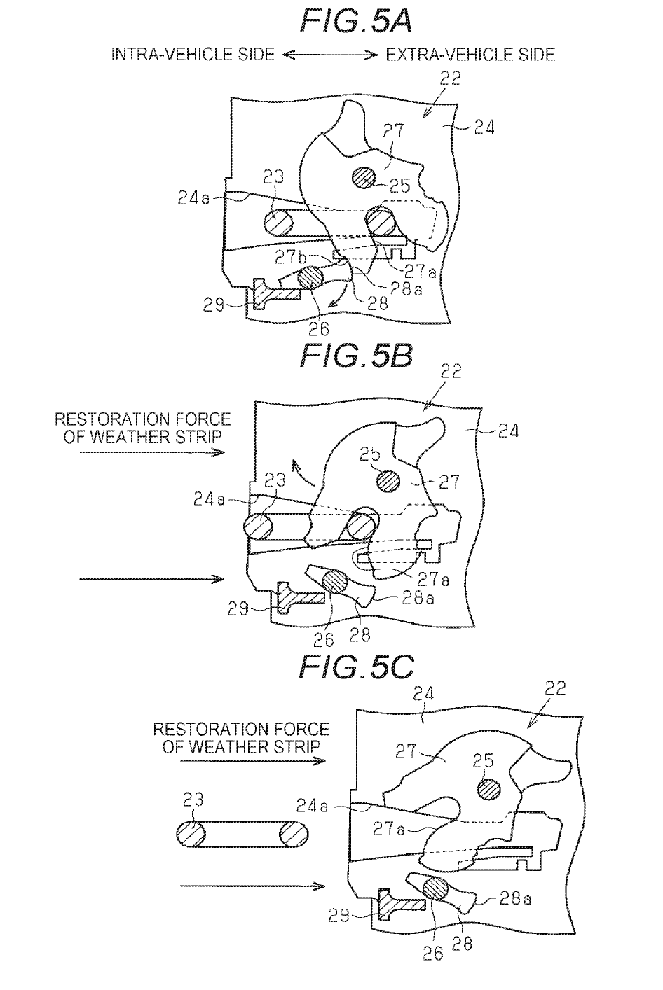

As illustrated in FIG. 5A, the latch mechanism 22 includes a base plate 24, a latch 27, and a pawl 28.

The base plate 24 is fixed to the swing door 10. The base plate 24 has a slit-shaped striker entrance/exit groove 24a.

The latch 27 is rotatably provided with respect to a rotating shaft 25, which is fixed to the base plate 24. The latch 27 has a substantially flat plate shape having a striker engagement groove 27a, which is open in the outer peripheral surface thereof. In addition, the latch 27 is urged to rotate in a clockwise direction in FIG. 5A by the elastic force of a torsion coil spring (not illustrated). In the locked state where the striker 23 is sandwiched between the striker engagement groove 27a in the latch 27 and the striker entrance/exit groove 24a, the rotation of the latch 27 in the clockwise direction is restricted when the pawl 28 is engaged with the outer peripheral surface of the latch 27. Thereby, the latch 27 is maintained in the locked state.

The pawl 28 is rotatably provided with respect to a rotating shaft 26, which is fixed to the base plate 24. An engagement portion 28a is provided at a first end portion (a right end portion in the drawing) of the pawl 28. The engagement portion 28a is engaged with the outer peripheral surface of the latch 27 to maintain the latch 27 in the locked state. The pawl 28 is urged to rotate in a counterclockwise direction in FIG. 5A by the elastic force of a torsion coil spring (not illustrated). The rotation of the pawl 28 in the counterclockwise direction is restricted when a second end portion (a left end portion in the drawing) of the pawl 28 abuts on an engagement element 29 provided on the base plate 24. At this time, when the engagement portion 28a of the pawl 28 is engaged with a first engagement portion 27b provided on the outer peripheral surface of the latch 27, the latch 27 is maintained in the locked state where the striker 23 is sandwiched between the striker entrance/exit groove 24a and the engagement portion 28a of the pawl 28. In addition, the pawl 28 rotates in the clockwise direction in FIG. 5A against the elastic force of the torsion coil spring by the driving of the electric actuator.

An operation when the latch mechanism 22 switches from the locked state to the unlocked state will be described.

As illustrated in FIG. 5A, in the locked state of the latch mechanism 22, when the electric actuator is driven based on the signals output from the contact sensors 51a, 51b and 51c, the pawl 28 rotates in the clockwise direction indicated by the arrow in FIG. 5A.

As illustrated in FIG. 5B, the engagement between the engagement portion 28a of the pawl 28 and the latch 27 is released by the driving of the electric actuator. Then, the latch 27 rotates in the clockwise direction in FIG. 5B by the elastic force of the torsion coil spring. When the latch 27 rotates in the clockwise direction, the striker 23 moves relative to the latch 27 in the direction (the leftward direction in FIG. 5B) in which it is separated from the striker entrance/exit groove 24a. However, when the latch 27 begins to rotate in the clockwise direction, the engagement state between the latch 27 and the striker 23 is not completely released, and is set to a so-called half lock state where the striker 23 abuts on the inner wall (the left surface in FIG. 5B) of the striker engagement groove 27a in the latch 27. When the engagement state between the latch 27 and the striker 23 is set to the half lock state, the swing door 10 is in the half-opened state. The restoration force of the weather strip, which has been forcibly crushed between the swing door 10 and the door opening, is applied to the swing door 10 in the direction in which the swing door 10 is operated to open, whereby the swing door 10 pops up in the opening operation direction.

As illustrated in FIG. 5C, along with the further movement of the swing door 10 urged by the restoration force of the weather strip in the opening operation direction, the striker 23 moves in the direction in which the striker 23 retreats from the striker engagement groove 27a (the leftward direction in FIG. 5C), whereby the latch 27 further rotates in the clockwise direction by the elastic force of the torsion coil spring. Eventually, the latch 27 reaches the position at which an opening in the striker engagement groove 27a faces the striker entrance/exit groove 24a. At this timing, the engagement between the striker entrance/exit groove 24a and the striker 23 is released, and the striker 23 may be separated from the striker entrance/exit groove 24a. The rotation of the latch 27 in the clockwise direction is restricted when the latch 27 abuts on a stopper (not illustrated) provided on the base plate 24.

In addition, the door lock device 21 has a mechanical configuration (not illustrated), which also switches the latch mechanism 22 from the locked state to the unlocked state by the operation of the inside handle 50 and the outside handle 60.

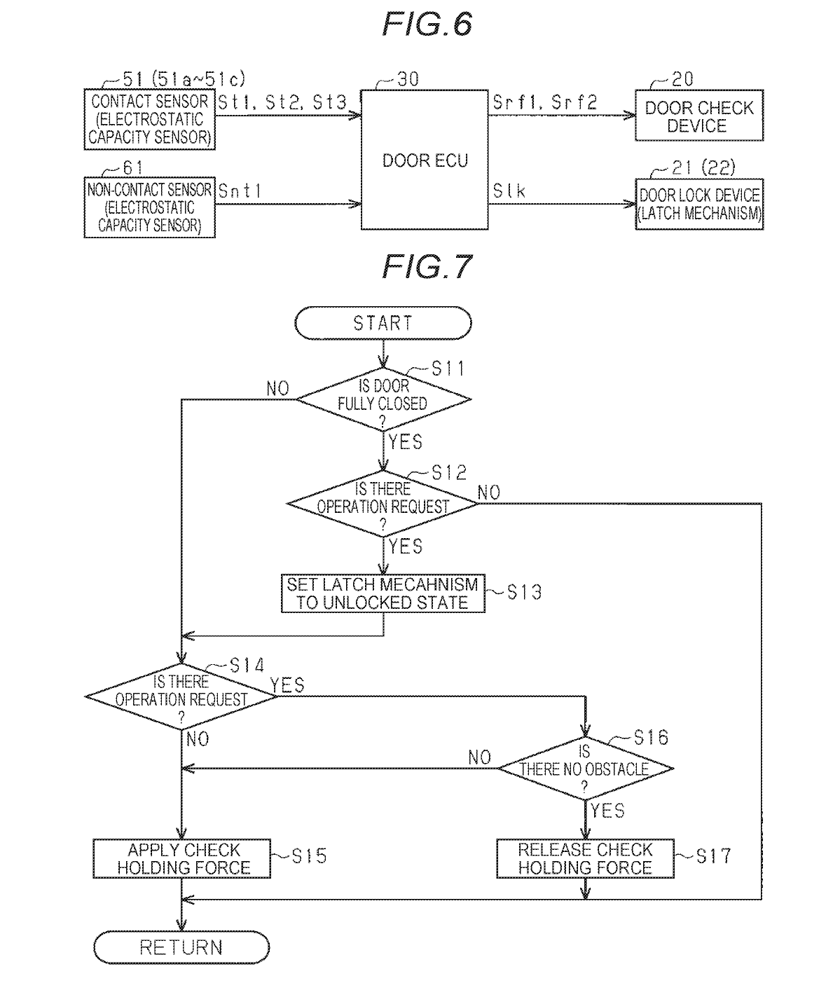

As illustrated in FIG. 6, the swing door 10 is provided with a door ECU 30 as a controller. The door ECU 30 controls operations of the door check device 20 and the door lock device 21.

The door ECU 30 receives signals St1, St2 and St3 output from the contact sensors 51a, 51b and 51c and a signal Snt1 output from the non-contact sensor 61. The signal St1 indicates an operation request from the operator who tries to open the swing door 10 using the inside handle 50. The signal St2 indicates an operation request from the operator who tries to open the swing door 10 using the grip part 54. The signal St3 indicates an operation request from the operator who tries to open the swing door 10 using the outside handle 60. The signal Snt1 is a signal indicating that there is an object that approaches the swing door 10 from the outside. The door ECU 30 generates signals Slk, Srf1 and Srf2 based on these signals St1, St2, St3 and Snt1. The signal Slk is a signal for switching the engagement state of the latch mechanism 22 from the locked state to the unlocked state by the operator. The signal Srf1 is a signal for controlling the door check device 20 so as not to apply the check holding force to the swing door 10. The signal Srf2 is a signal for controlling the door check device 20 so as to apply the check holding force to the swing door 10. In addition, the door ECU 30 also receives a signal output from a courtesy switch (not illustrated). The courtesy switch detects the opening/closing state of the swing door 10. The signal output from the courtesy switch is a signal indicating that the swing door 10 is at the fully closed position.

Next, the control flow of the door ECU 30 will be described.

As illustrated in FIG. 7, first, the door ECU 30 determines whether or not the swing door 10 is in the fully closed state (step S11). That is, the door ECU 30 determines whether or not the signal output from the courtesy switch is detected. When determining that the swing door 10 is in the fully closed state (YES in step S11), the door ECU 30 determines whether or not there is an operation request of the swing door 10 (step S12). That is, the door ECU 30 determines whether or not any one of the signals St1, St2 and St3 is detected. When determining that there is no operation request of the swing door 10 (NO in step S12), the door ECU 30 ends the processing (RETURN). When determining that there is the operation request of the swing door 10 (YES in step S12), the door ECU 30 switches the engagement state of the latch mechanism 22 from the locked state to the unlocked state (step S13). That is, the door ECU 30 outputs the signal Slk to the door lock device 21. Thereafter, the door ECU 30 determines whether or not the operation request of the swing door 10 is still continued (step S14). When determining that the operation request of the swing door 10 is not continued (NO in step S14), the door ECU 30 applies the check holding force to the swing door 10 via the door check device 20 (step S15). That is, the door ECU 30 outputs the signal Srf2 to the door check device 20. When determining that the operation request of the swing door 10 is continued (YES in step S14), the door ECU 30 determines whether or not there is an obstacle on the rotation locus R of the swing door 10 (step S16). That is, the door ECU 30 determines whether or not the signal Snt1 is detected. When determining that there is no obstacle on the rotation locus R of the swing door 10 (YES in step S16), the door ECU 30 releases the check holding force for the swing door 10 via the door check device 20 (step S17). That is, the door ECU 30 outputs the signal Srf1 to the door check device 20. When determining that there is an obstacle on the rotation locus R of the swing door 10 (NO in step S16), the door ECU 30 shifts the processing to step S15. In step S11, when determining that the swing door 10 is not in the fully closed state (NO in step S11), the door ECU 30 shifts the processing to step S14.

As described above, according to the present embodiment, the following action effects may be obtained.

(1) The door ECU 30 executes the control of the door lock device 21 and the control of the door check device 20 by using, as a trigger, signals St1, St2 and St3, which are the operation request of the swing door 10 by the operator, output from the operation detection unit 51. Therefore, a time lag between the timing at which the latch mechanism 22 is set to the unlocked state and the timing at which the check holding force for the swing door 10 is released is suppressed, as compared with a case where the execution triggers of the control of the door lock device 21 and the control of the door check device 20 are different. When the operator performs an operation of opening the swing door 10, the operator may smoothly open the swing door 10 since the check holding force for the swing door 10 is released substantially at the same time as when the swing door 10 is switched to the unlocked state with respect to the vehicle body 2. Thus, the operational feeling of the swing door 10 may further be improved.

(2) Even if the latch mechanism 22 is switched to the unlocked state when opening the swing door 10, the swing door 10 may not be smoothly opened when the check holding force is applied to the swing door 10. For example, since the pop-up of the swing door 10, in which the weather strip is accommodated in a forcibly crushed manner between the swing door 10 and the door opening, is suppressed by the check holding force, the striker 23 may not be completely separated from the striker engagement groove 27a in the latch 27. That is, the engagement state of the striker 23 and the latch 27 may be maintained in the half-locked state where the striker and the latch are not completely released. In this state, when the operator tries to open the swing door 10, the swing door 10 and the door lock device 21 may be engaged with each other and the swing door 10 may not be opened smoothly.

In that respect, according to the vehicle door apparatus of this example, when beginning to open the swing door 10 in the fully closed state, the check holding force is not applied to the swing door 10. Therefore, it is possible to smoothly open the swing door 10. In addition, when there is no operation request by the operator in a state where the swing door 10 is released from the fully closed state, the check holding force is applied to the swing door 10. The swing door 10 is held at an appropriate degree of opening. A series of operations from the switching of the latch mechanism 22 to the unlocked state to the holding of the swing door 10 via the opening operation of the swing door 10 are performed smoothly.

(3) The door ECU 30 switches the latch mechanism 22 to the unlocked state when there is the operation request of the swing door 10 when the swing door 10 is in the fully closed state, and thereafter determines whether or not the operation request of the swing door 10 is continued. The door ECU 30 controls the door check device 20 so that the check holding force is not applied to the swing door 10 when there is the operation request, and controls the door check device 20 so that the check holding force is applied to the swing door 10 when there is no operation request. Thereby, it is possible to improve the safety of the vehicle door apparatus while improving the operational feeling of the swing door 10.

(4) When an obstacle on the rotation locus R of the swing door 10 is detected, the door ECU 30 controls the door check device 20 so as to apply the check holding force to the swing door 10 before the obstacle comes into contact with the swing door 10. Therefore, it is possible to hold the swing door 10 before the swing door 10 comes into contact with the obstacle. Thus, the safety of the vehicle door apparatus is further improved.

In addition, it should be noted that the present embodiment may be modified as follows within a range in which technological inconsistency does not occur.

In the present embodiment, when determining that the operation request of the swing door 10 is continued (YES in step S14 in FIG. 7), the door ECU 30 determines whether or not there is an obstacle on the rotation locus R of the swing door 10 (step S16 in FIG. 7). In this case, when the operator approaches the swing door 10 from the outside of the vehicle 1, the operator may be detected as an obstacle by the non-contact sensor 61. Therefore, when the non-contact sensor 61 is used as the obstacle detection unit, whether or not the operation request of the swing door 10 is continued may be determined by the contact sensors 51a and 51b on the indoor side of the swing door 10.

In consideration of the above modification, in the present embodiment, the door ECU 30 determines whether or not there is an obstacle on the rotation locus R of the swing door 10 based on the signal Snt1 of the non-contact sensor 61 as the obstacle detection unit, but the disclosure is not limited thereto. For example, the door ECU 30 may directly image an obstacle by an in-vehicle camera, which serves as an obstacle detection unit, and may determine whether or not there is an obstacle on the rotation locus R of the swing door 10 based on image data.

In addition, the obstacle detection unit, which includes the non-contact sensor 61 according to the present embodiment and the in-vehicle camera according to the modification, may be omitted. In this case, step S16 in the flowchart of FIG. 7 is also omitted. In a case of YES in step S14, the processing proceeds to step S17.

One of the contact sensor 51a and the contact sensor 51b may be omitted. That is, the operation detection unit 51 may be constituted of the contact sensors 51a and 51c, or may be constituted of the contact sensors 51b and 51c. In this case, the door ECU 30 implements the control of the door lock device 21 and the control of the door check device 20 in response to one of the signal St1 and the signal SQ.

In the present embodiment, the operation detection unit 51 is constituted of the contact sensors 51a, 51b and 51c, but these contact sensors may be replaced with non-contact sensors. Even in this case, the operation detection unit 51 may detect the operation request of the swing door 10 by the operator.

In addition, in the present embodiment, the door check device 20 is configured to maintain a state where the check holding force is applied to the swing door 10 when the swing door 10 is in the fully closed state, but the disclosure is not limited thereto. For example, when the swing door 10 is in the fully closed state, the door check device 20 may maintain a state where no check holding force is applied to the swing door 10. By maintaining the state where no check holding force is applied, it is possible to smoothly open the swing door 10 after switching the latch mechanism 22 to the unlocked state. In that case, step S17 in the control flow of this example is changed to a processing of maintaining a state where the check holding force is released.

In the present embodiment, the vehicle door apparatus has been described as being embodied in each of the swinging doors 10 provided on the side surface of the vehicle 1, but may be equally applied to, for example, a center opening type backdoor, a left and right hinged type backdoor, or a lateral opening type backdoor, which is provided on the rear portion of the vehicle 1.

A vehicle door apparatus according to an aspect of this disclosure includes an electric door lock unit configured to switch an operating state thereof between a locked state of restricting an opening/closing operation of a swing door with respect to a vehicle body and an unlocked state of permitting the opening/closing operation of the swing door with respect to the vehicle body, an operation detection unit configured to detect an operation request of the swing door by an operator, an electric door check unit provided on the swing door and configured to switch an operating state thereof between a holding state of applying a holding force to the swing door for holding the swing door at an arbitrary degree of opening and a non-holding state of not applying the holding force to the swing door, and a controller configured to switch the electric door lock unit from the locked state to the unlocked state and to set the electric door check unit in the non-holding state when the operation request is detected via the operation detection unit.

According to this configuration, the controller executes the control of the electric door lock unit and the control of the door check unit in response to the operation request of the swing door by the operator, which is detected by the operation detection unit, as a trigger. Therefore, a time lag between the timing at which the electric door lock unit is set to the unlocked state and the timing at which the holding force for the swing door is released is suppressed, as compared with a case where the execution triggers of the control of the electric door lock unit and the control of the electric door check unit are different. When the operator performs an operation of opening the swing door, the operator may smoothly open the swing door since the holding force for the swing door is released substantially at the same time as when the swing door is switched to the unlocked state with respect to the vehicle body. Thus, the operational feeling of the swing door may further be improved.

In the vehicle door apparatus according to the aspect of this disclosure, the controller may set the electric door check unit to the non-holding state when the operation request is detected after switching the electric door lock unit to the unlocked state, and may set the electric door check unit to the holding state when the operation request is not detected.

According to this configuration, when opening the swing door, no holding force is applied to the swing door. Therefore, it is possible to smoothly open the swing door. In a case where the swing door is in the opened state, the holding force is applied to the swing door when there is no operation request by the operator. The swing door is held at an appropriate degree of opening. A series of operations from the switching of the electric door lock unit to the unlocked state to the holding of the swing door via the opening operation of the swing door are performed smoothly. In addition, in a case where the swing door is in the opened state, the controller controls the electric door check unit so that no holding force is applied to the swing door when there is the operation request, and controls the electric door check unit so that the holding force is applied to the swing door when there is no operation request. Thereby, it is possible to improve the safety of the vehicle door apparatus while improving the operational feeling of the swing door.

The vehicle door apparatus according to the aspect of this disclosure may further include an obstacle detection unit configured to detect an object located on a rotation locus of the swing door, and, when the operation request is detected after the electric door lock unit is switched to the unlocked state, the controller may set the electric door check unit to the holding state when the object on the rotation locus of the swing door is detected by the obstacle detection unit, and may set the electric door check unit to the non-holding state when the object is not detected.

According to this configuration, when an obstacle on the rotation locus of the swing door is detected, the holding force is applied to the swing door. Therefore, it is possible to hold the swing door before the swing door comes into contact with the obstacle. Thus, the safety of the vehicle door apparatus is further improved.

In the vehicle door apparatus according to the aspect of this disclosure, the operation detection unit may be provided on each of a vehicle inner side and a vehicle outer side of the swing door, and the obstacle detection unit may detect the object located on the rotation locus of the swing door when the operation request is detected by the operation detection unit provided on the vehicle inner side of the swing door.

According to this configuration, when the operator of the swing door attempts to open the swing door from the vehicle outer side, it is possible to prevent the operator from being detected as an obstacle by the obstacle detection unit. Therefore, it is possible to smoothly open the swing door even when opening the swing door from the outside of the vehicle.

According to the vehicle door apparatus according to the aspect of this disclosure, it is possible to further improve the operational feeling of a swing door.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door apparatus comprising:
an electric door lock unit configured to switch an operating state between a locked state of restricting an opening/closing operation of a swing door with respect to a vehicle body and an unlocked state of permitting the opening/closing operation of the swing door with respect to the vehicle body;
an operation detection unit configured to detect an operation request of the swing door by an operator;
an electric door check unit provided on the swing door and configured to switch an operating state between a holding state of applying a holding force to the swing door for holding the swing door at an arbitrary degree of opening and a non-holding state of not applying the holding force to the swing door; and
a controller configured to switch the electric door lock unit from the locked state to the unlocked state and to set the electric door check unit in the non-holding state when the operation request is detected via the operation detection unit.

2. The vehicle door apparatus according to claim 1,
wherein the controller sets the electric door check unit to the non-holding state when the operation request is detected after switching the electric door lock unit to the unlocked state, and sets the electric door check unit to the holding state when the operation request is not detected.

3. The vehicle door apparatus according to claim 1, further comprising an obstacle detection unit configured to detect an object located on a rotation locus of the swing door,
wherein, when the operation request is detected after the electric door lock unit is switched to the unlocked state, the controller sets the electric door check unit to the holding state when the object on the rotation locus of the swing door is detected by the obstacle detection unit, and sets the electric door check unit to the non-holding state when the object is not detected.

4. The vehicle door apparatus according to claim 2, further comprising an obstacle detection unit configured to detect an object located on a rotation locus of the swing door,
wherein, when the operation request is detected after the electric door lock unit is switched to the unlocked state, the controller sets the electric door check unit to the holding state when the object on the rotation locus of the swing door is detected by the obstacle detection unit, and sets the electric door check unit to the non-holding state when the object is not detected.

5. The vehicle door apparatus according to claim 3,
wherein the operation detection unit is provided on each of a vehicle inner side and a vehicle outer side of the swing door, and
the obstacle detection unit detects the object located on the rotation locus of the swing door when the operation request is detected by the operation detection unit provided on the vehicle inner side of the swing door.

6. The vehicle door apparatus according to claim 4,
wherein the operation detection unit is provided on each of a vehicle inner side and a vehicle outer side of the swing door, and
the obstacle detection unit detects the object located on the rotation locus of the swing door when the operation request is detected by the operation detection unit provided on the vehicle inner side of the swing door.
